(19) United States
(12) Patent Application Publication
(10) Pub. No.: US 2026/0279370 A1
(43) Pub. Date: Sep. 17, 2026

(54) Decoder and encoder for energy in bandwidth extension

(71) Applicant: Fraunhofer-Gesellschaft zur Förderung der angewandten Forschung e.V., München (DE)

(72) Inventors: Domenico TIZIANI, Erlangen (DE); Guillaume FUCHS, Erlangen (DE); Martin MÜLLER, Erlangen (DE); Matthias NEUSINGER, Erlangen (DE); Markus SCHNELL, Erlangen (DE); Suraj PANDEY, Erlangen (DE); Srikanth KORSE, Nürnberg (DE)

(73) Assignee: Fraunhofer-Gesellschaft zur Förderung der angewandten Forschung e.V., München (DE)

(21) Appl. No.: 19/669,968

(22) Filed: May 6, 2026

Related U.S. Application Data
(63) Continuation of application No. PCT/EP2024/081753, filed on Nov. 8, 2024.

(30) Foreign Application Priority Data
Nov. 10, 2023 (EP) 23209167.8

(51) Int. Cl. G10L 19/12; G10L 19/032

(52) U.S. Cl. CPC G10L 19/12; G10L 19/032

(57) ABSTRACT

Encoder for coding a signal having a band-limited signal and an extended-band signal, the encoder having: a calculator configured to perform energy prediction of the extended-band signal based on LPC coefficients; and a coder configured to encode a residual of the signal using the energy prediction and an offset; wherein the offset is dependent on a bit-rate.

### CROSS-REFERENCE TO RELATED APPLICATIONS

This application is a continuation of International Application No. PCT/EP2024/081753, filed Nov. 8, 2024, which is incorporated herein by reference in its entirety, and additionally claims priority from European Application No. 23209167.8, filed Nov. 10, 2023, which is also incorporated herein by reference in its entirety.

### TECHNICAL FIELD

Embodiments of the present invention refer to an audio processor as well as to corresponding methods. The audio processor may be a decoder or an encoder or part of a decoder or encoder. Thus embodiment refer to an encoder and decoder. Preferred embodiments refer to advanced energy and gain coding in an audio bandwidth extension.

### BACKGROUND OF THE INVENTION

Bandwidth extension (BWE) is a technique used in speech and audio coding to enhance the quality of speech or audio transmission in situations where the available bandwidth or the possible bit-rate is limited. In essence, it is a method of expanding the frequency range of a speech baseband coder, like Code-excited linear prediction (CELP), beyond the Nyquist frequency of its internal sampling rate, which can improve the perceived quality of the reconstructed speech or audio signal at the decoder side. Usually, the bandwidth extension techniques in speech and audio coding, transmit no, or very few additional parameters, and required therefore no or very limited extra bit-rate over the baseband coder.

The Waveform Envelope Synchronized Pulse Excitation WESPE is an example of an efficient bandwidth extension, which can retain the original high-frequency (HF) fine structure, while being more controllable than the systematic copying, shifting, mirroring, or non-linear operations, usually used in this type of system. The procedure relies on the extraction of a relevant time envelope and the position of pulses at its maxima. In this way, WESPE is able to extent harmonic structures to HF, and for noisier signal could also create pretty noisy fine structure.

Bandwidth extension is very well studied and established technique, already deployed in different existing standard like, HeAAC and 3GPP EVS. It usually built over a baseband coder, like a speech coder of type CELP or a generic transform-based audio coding, like AAC or TCX. In consequence, bandwidth extension can be performed either in time domain, or in frequency domain or in both domains. However, the great majority of the techniques dissociate the modelling of the frequency fine structure, called excitation in Time Domain, and coarse spectral structure, also called spectral envelope.

For great bit saving, the principle is based on generating the fine structured high frequency content from the transmitted low frequency content from the baseband coder. The high frequencies are then spectral shaped and/or post processed before being mixed at the decoder side to the decoded baseband. The whole process can be steered by transmitted parameters.

One usual and efficient way of doing is to split the original signal and bandwidth in two frequency bands, low and high, and then perform individual short-term linear prediction analysis to decompose the fine structure (excitation) and the spectral envelope modelling. For example AMR-WB+ and EVS use this principle when CELP as baseband coder.

It has been found out that the HF reconstruction can be done in some cases in a quite simple manner. Furthermore, it has been found out that a ratio of energies between LF and HF excitation might be influenced by the bit rate used by the baseband coder, wherein different bit rates are typically not optimal or supported.

Therefore, there is need for an improved approach.

### SUMMARY

According to an embodiment, an encoder for coding an audio signal having a band-limited signal and an extended-band signal, may have: a baseband encoder configured to encode the band-limited signal at a given bit-rate; and a bandwidth extension encoder which has: an energy prediction calculator configured to perform an energy prediction of the extended-band signal based on linear prediction coefficients; and a gain encoder configured to code extended-band gains based on the energy prediction and an offset; wherein the offset is dependent on the given bit-rate or a coding mode of baseband encoder.

According to another embodiment, a decoder for decoding a signal having a band-limited signal and an extended-band signal, may have: a baseband decoder configured to decode the bandlimited signal at a given bit-rate; and a bandwidth extension decoder which has: an energy prediction calculator configured to perform energy prediction of the extended-band signal based on linear prediction coefficients; and an gain decoder configured to decode an extended-band gains based on the energy prediction and an offset or a bias.

According to another embodiment, a decoder for decoding a signal having a band-limited signal and an extended-band signal, may have: a baseband decoder configured to decode the bandlimited signal at a given bit-rate; and a bandwidth extension decoder which has: a energy prediction calculator configured to perform energy prediction of the extended-band signal based on linear prediction coefficients; and an gain estimator configured to estimate an extended-band gains based on the energy prediction and an estimate of the energy prediction residue.

According to another embodiment, a method for encoding a signal having a band-limited signal and an extended-band signal, may have the steps of: encoding the bandlimited signal at a given bit-rate; and performing an energy prediction of the extended-band signal based on linear prediction coefficients; and coding extended-band gains based on the energy prediction and an offset; wherein the offset is dependent on the given bit-rate or a coding mode of baseband encoder.

According to another embodiment, a method for decoding a signal having a band-limited signal and an extended-band signal, may have the steps of: decoding the bandlimited signal at a given bit-rate, and performing energy prediction of the extended-band signal based on linear prediction coefficients; and decoding an extended-band gains based on the energy prediction and an offset or a bias; wherein the offset is dependent on the given bit-rate or a coding mode.

According to another embodiment, a method for decoding a signal having a band-limited signal and an extended-band signal, may have the steps of: decoding the bandlimited signal at a given bit-rate; and preforming energy prediction of the extended-band signal based on linear prediction coefficients; and estimating an extended-band gains based on the energy prediction and an estimate of the energy prediction residue.

Still another embodiment may have a non-transitory digital storage medium having stored thereon a computer program for performing the above methods according to the invention when the computer program is run by a computer.

An embodiment provides an encoder for coding a signal comprising the band-limited signal and an extended-band signal. The encoder comprises a calculator and a coder. The calculator is configured to perform an entry prediction of the extended-band signal based on LPC coefficients (linear prediction coefficients). The coder is configured to encode a residual of the signal using the energy prediction and an offset. The offset is dependent on a bit rate or at least a bit.

Embodiments of the present invention are based on the finding that by applying an offset or bias which depends on the bit rate when predicting the energy prediction a single optimum energy coding scheme for different bit rates can be designed. This supports the designing of an efficient coding of energy information of the extended band which is flexible enough for supporting different bit rates and reducing its own bit requirement. The result is a more efficient energy and gain coding as in the known bandwidth extension. The energy can be coded with very few bits exploiting a prediction from the base band.

According to embodiments, the LPC coefficients comprises coefficients of the band-limited signal and the extended-band signal. This helps to get a consistent energy between limited and extended bands independently of the bit rate and the energy attenuation happening in the baseband coder can be measured or estimated. It can, for example, be achieved by computing at a training time energy biases implicitly introduced by the baseband coder, like CELP.

According to embodiments, the calculator performs the energy prediction based on the LPC coefficients and a coded band-limited excitation. According to embodiments, the prediction calculator may be configured to compute a ratio of energies involving filters derived from the linear coefficients of the band-limited signal and the extended-band signal.

According to embodiments, a coding may be performed using a single codebook command to at least two bit rates. This allows sharing the same codebook among bit rates.

Another embodiment provides a decoder for decoding (in general processing) a signal comprising a band-limited signal and an extended-band signal. The decoder comprises a calculator and a energy decoder. The calculator is configured to perform energy prediction of the extended-band signal based on LPC coefficients. The energy decoder is configured to decode an extended-band signal of the signal using the energy prediction and a part of a bias for reinstituting energy of the extended-band signal.

According to embodiments, the decoding is performed as part of a offset (bias) for reinstituting energy of the extended-band signal, wherein the offset is dependent on the bit rate.

Another embodiment provides a decoder for decoding a signal comprising a band-limited signal and an extended-band signal. The decoder comprises learnable modules like a DNN (deep neural network) and the decoder itself. The learnable modules or the DNN is configured to estimate the energy prediction of the extended-band signal, wherein the decoder is configured to decode an extended-band signal of the signal using the energy prediction.

According to embodiments, the extended-band gains are estimated by estimating a residue of the energy prediction using a machine learning algorithm or DNN uses at least one learnable layer of parameters. For example, the at least one learnable layer comprises at least one fully connected layer or at least one convolutional layer or at least one recurrent layer. Additionally or alternatively, the at least one learnable layer is associated with an activation function (like a ReLU, leaky ReLU . . . ). The at least one learnable layer may take receive as input a frequency representation of the decoded band-limited band or of a filter derived from LPC coefficients as input. According to embodiments, the at least one learnable layer takes as input a frequency representation of the decoded band-limited band of a current frame and at least one frequency representation of the decoded band-limited band of previous frames.

This enables a decoder-only prediction refinement based on machine learning techniques for refining the first energy estimation according to embodiments.

Further embodiments provides a method for encoding a signal. The method comprises performing energy prediction of the extended-band signal based on LPC coefficients; and encoding a residual of the signal using the energy prediction and an offset. Note the offset is dependent on a bit rate again.

Another embodiment provides a method for decoding a signal. The method comprises performing energy prediction of the extended-band signal based on LPC coefficients; and decoding an extended-band signal of the signal using the energy prediction and a part of an offset (bias) for restituting energy of the extended-band signal. Again the offset is dependent on a bit rate.

Another embodiment provides a method for decoding a signal. The method comprises one of the following steps: estimating energy prediction of the HF signal using learnable modules like a learning machine approach or like a DNN; and decoding an extended-band signal of the signal using the energy prediction.

Embodiments of the present invention may be computer implemented. Thus, an embodiment provides a computer program for performing the steps of the above defined methods.

### BRIEF DESCRIPTION OF THE DRAWINGS

Below, embodiments of the present invention will subsequently be discussed referring to the enclosed figures, in which:

FIG. 1a shows the basic implementation of an energy encoder, especially an extended-band energy encoder according to an embodiment;

FIG. 1b shows schematically an energy decoder, especially a basic implementation of an extended-band energy decoder according to another embodiment;

FIG. 1c shows schematically an energy estimator, especially a basic implementation of an extended band energy estimator according to a further embodiment;

FIG. 2 shows a block diagram for a level zero of the split band encoder, involving the baseband encoder and the bandwidth-extension (BWE) encoder and according to further embodiments;

FIG. 3 shows a schematic illustration of two band systems realized with block transforms, namely DFTs according to further embodiments;

FIG. 4 shows a schematic block diagram of a BWE encoder according to further embodiments;

FIG. 5 shows a schematic block diagram of a level zero of the split band decoder, involving the baseband decoder and the bandwidth extension (BWE) decoder according to embodiments;

FIG. 6a shows a block diagram illustrating a known (3GPP AMR-WB+ standard) higher frequency encoding; and

FIG. 6b shows a block diagram of a known high frequency decoding.

### DETAILED DESCRIPTION OF THE INVENTION

Below, embodiments of the present invention will subsequently be discussed referring to the enclosed figures, wherein identical reference numbers are provided to objects having identical or similar functions so that the description thereof is interchangeable and mutually applicable.

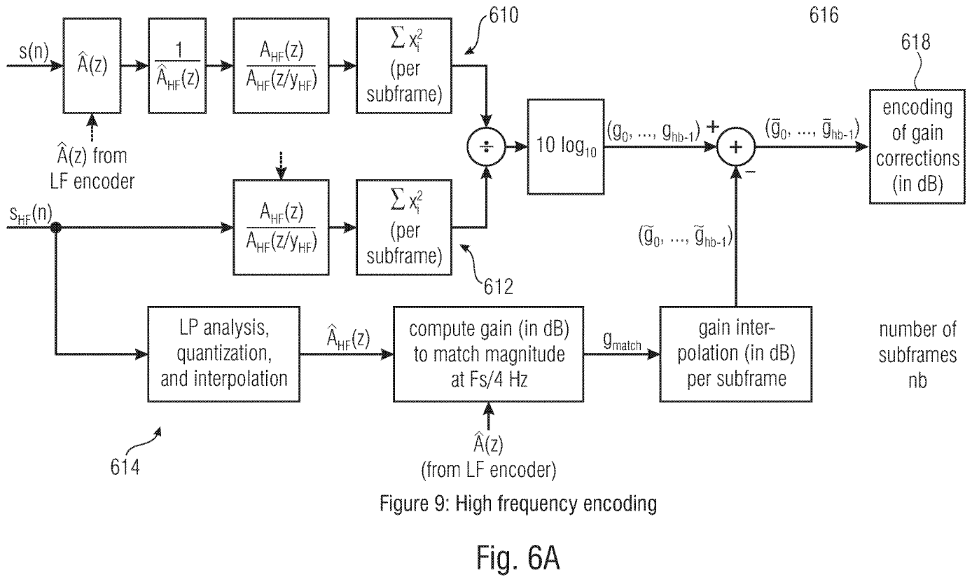

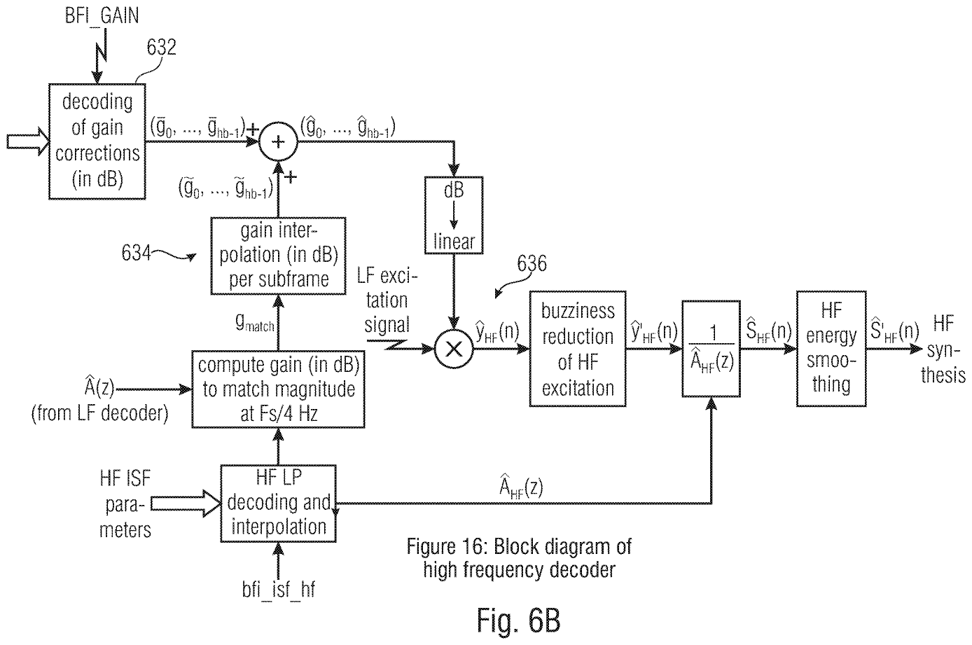

FIG. 6a shows known steps/entities used for high frequency encoding in the 3GPP AMR-WB+. Here, the input signals s(n) and s_{hf(n)} are processed by the respective encoding paths 610 and 612, wherein the LP analysis is performed in parallel within the paths 614 based on the signal s_{hf(n)}. The output of the two paths 610 and 612 are combined with the output of the path 614 so as to obtain the gain and/or the encoding of the gain corrections (cf. block 618). Note, within the respective paths an input from the LF encoder, namely for the coefficients of the filter Â(z) are used.

FIG. 6b shows a block diagram of a higher frequency decoder receiving the coded HF ISF parameters, the coded gain corrections and the decoded LF excitation signal from the LF decoder. In the entity 632 the gain corrections are decoded, wherein the output gain correction values are then combined with a gain prediction 634 computed from a comparison of the decoded LPC Â(z) from the LF decoder and the Â_HF(z) deduced from the received HF ISF parameters so as to obtain the resulting HF gains for each sub-frame. The HF gains are then applied (cf. 636) to decoded LF excitation, being eventually further processed to reduce buzziness before being filter by the synthesis filter 1/Â_HF(z) to obtain the HF synthesis signal, which can be eventually further post-processed by some energy smoothing. Both block diagrams of FIGS. 6a and 6b concern the coding energy of an HF excitation in the high band. The presented coding scheme has two major limitations.

First, it only works if the LF excitation is used directly for HF reconstruction by simple processing such as copying, shifting and mirroring. Second, the coding is not optimal when supporting different bit rates, where the ratio of energies between decoded LF excitation and the original HF excitation changes with the bit-rate. Indeed, the energy of the low-frequency (LF) from the baseband coder is expected to decrease with the bit-rate the ratio is then expected to increase. By using one quantization scheme for all bit-rates, some uncontrolled biases and/or suboptimalities are then inserted. The present invention aims at addressing these two main drawbacks.

It has been found out that by use of a bias, also referred to as offset, the energy coding of the extended-band signal can be improved at both the encoder and decoder sides. The main objective of the present invention is to restitute the appropriate energy of the extended-band signal, either by coding the energy at the encoder and transmitting one or several energy parameters or by estimating it at the decoder side without any associated transmitted information.

The first embodiment of the proposed invention consists of an energy encoder, which is part of a bandwidth extension encoder. It comprises three processing blocks. The first is the target energy calculator, which computes the energy of the original bandwidth-extended signal or its processed version. The second processing block is an energy prediction calculator, which calculates an energy prediction from the parameters or signals already encoded by the baseband and/or extended-band encoder. The residue of the energy prediction is then coded and transmitted, by subtracting or adding an offset or bias, related to the bit rate and a range of bit-rate. This may involve, for example, normalizing the residue by subtracting its average compiled offline in a training phase from a given bit-rate or a range of bit rates. The merit of applying a bias or offset is to get a normalized residue to code, which make its coding mor efficient. Moreover, its statistics are more common amongst different bit-rates and conditions, and a common codebook can be beneficially adopted.

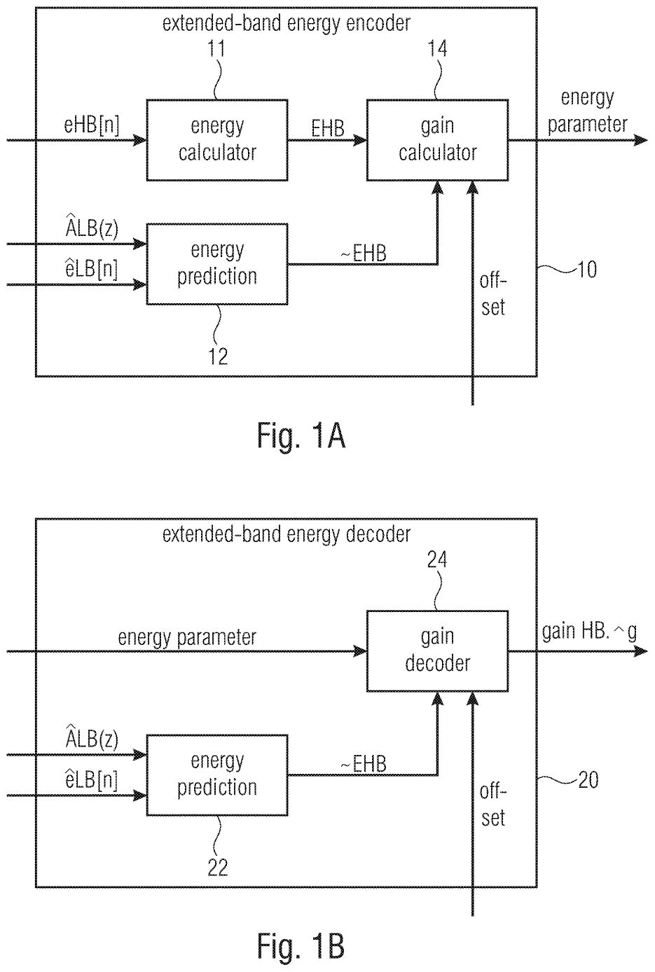

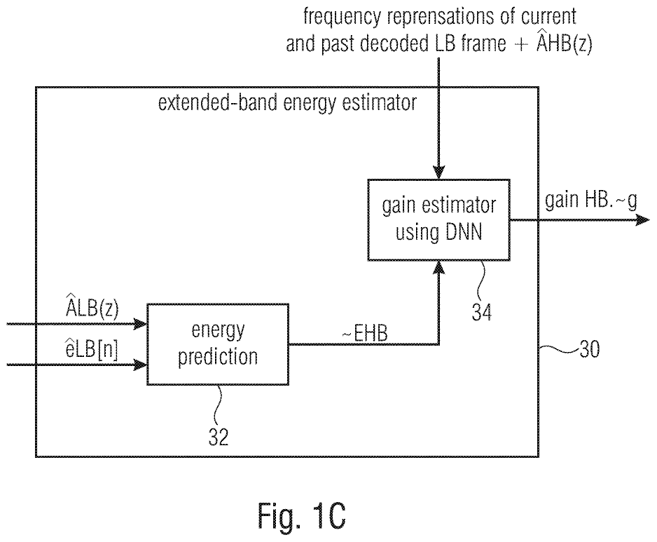

FIG. 1a shows a block diagram of an extended-band energy encoder 10 comprising an energy calculator 11, an energy prediction entity 12 and a gain encoder 14. The energy calculator 11 receives the residual signal eHB(n) which can be interpreted as extended-band signal. The energy prediction entity 12 receives the linear prediction coefficients together with a band limited signal eLB(n). Based on the energy calculation and the energy prediction, the gain encoder 14 codes the extended-band excitation gain. This is done based on the energy prediction and an offset. The output of the gain encoder 14 are the energy parameters which can be delivered to the decoder.

The detailed of energy coding is given below. First the excitation of extended-band is computed sub-frame wise by applying a linear prediction as stated before, and its energy is computed over a sub-frame as follows:

$${E}_{HB} = {\sum }_{n = 0}^{{L}_{sub} - 1} {{e}_{HB} ( n )}^{2}$$

The energy of the coded excitation of the band-limited excitation is computed the same way:

$${\hat{E}}_{LB} = {\sum }_{n = 0}^{{L}_{sub} - 1} {{\hat{e}}_{LB} ( n )}^{2}$$

Since Ê_{LB} is also available at the decoder side, the gain ratio E_{HB}/Ê_{LB} showing much less dynamic and energy needs only to be transmitted. This prediction of E_{HB} by E_{LB} can be even more improved by taking into account the LPC filters of the LF and HF bands. A prediction gain can be computed the energies ratio before and after the following filter:

$$H ( z ) = \frac{{\hat{A}}_{LB} ( z )}{{\hat{A}}_{HB} ( z )} .$$

In order to excite this filter with a frequency common to the two bands, the band-limited band (LF) and the extended-band (HF), a signal showing energy a the Nyquist frequency is used, like the following:

$${s}_{N} ( n ) = {s}_{N} ( n - 1 ) \cdot ( - 1 + α ) ,$$

Where s_{N}(0)=1, s_{N}(−1)=0, and α is an empirically found parameter to get the optimal prediction. In the advantageous embodiment, α=−0.008. If a is small, the energy of the signal s_{N}(n) for a sub-frame can be estimated as:

$${S}_{N} = {L}_{sub}$$

And its filtered version is then:

$${s}_{N}^{′} ( z ) = {s}_{N} ( z ) H ( z ) = {s}_{N} ( z ) \frac{{\hat{A}}_{LB} ( z )}{{\hat{A}}_{HB} ( z )}$$

The gain prediction is then given by:

$$gpred = \frac{{L}_{sub}}{{\sum }_{n = 0}^{{L}_{sub} - 1} {{s}_{N}^{′} ( n )}^{2}} .$$

For complexity reason the gain prediction can be computed only per 20 ms frame and then interpolated, for example linearly for each subframe. The energy prediction can be expressed as:

$${\tilde{E}}_{HB} [ i ] = {\hat{E}}_{LB} [ i ] \cdot gpred [ i ]$$

Finally, the energy gain ratio, i.e. the energy prediction residue to transmit can be expressed in dB as:

$$g [ i ] = 10 \cdot log 10 \frac{{E}_{HB} [ i ]}{{\hat{E}}_{LB} [ i ] \cdot gpred [ i ]}$$

where i is the subframe index. The gains of the subframe, i.e. 4 gains in case of 5 ms subframes in a 20 ms frame, can be then vector quantized. In case of low bit-rate, one gain per frame can be transmitted by averaging the gain in dB domain over the subframes:

$${g}^{′} = {\sum }_{i = 0}^{{N}_{sub} - 1} \frac{1}{{N}_{sub}} g [ i ] .$$

The offset has the purpose to compensate a mean shift or bias of the residue of the energy prediction. This mean shift might be dependent on the bitrate, so that the used offset is selected being dependent on the bitrate as well.

The vector quantized can performed for example by searching in a stochastic codebook as described by the following pseudo-code:

err_min = FLT_MAX;
idx = 0;
for ( k = 0; k < cdbk_size; ++k )
{
err = 0.0;
for (i = 0; i < N_sub; ++i )
{
err += (g [i] − cdbk[k][i] − offset[bit-rate])*
(g [i] − cdbk[k][i] − offset[bit-rate]);
}
if ( err < err_min )
{
err_min = err;
idx = k;
}
}

where cdbk is the gain codebook trained offline and saved in a table, and offset is a offset computed during the training and dependent for example of the bit-rate for removing a bias in the mean of the gain g. The offset can also be dependent of other factors or combination of factors, like the combination of a coder type line unvoiced or voiced speech and the bit-rate. As example of offset is given in the next table.

TABLE
offset for the energy gain coding, depending on the bit-
rates and the coding modes (UNVOICED, VOICED and GENERIC)

| | 32 | 24.4 | 16.4 | 13.2 | 9.6 | 8 |
|---|---|---|---|---|---|---|
| | KBPS | KBPS | KBPS | KBPS | KBPS | KBPS |
| UNVOICED | 0 | 0.75 | 1.6 | 2. | 2.1 | 2.2 |
| VOICED | 0 | 0.55 | 1.38 | 2.5 | 2.6 | 2.7 |
| GENERIC | 0 | 0.75 | 1.6 | 2.4 | 2.5 | 3.0 |

At the decoder side, the gain parameters are first decoded, and the decoded gains are combined with the same energy prediction made at the encoder side. The same bias or offset can be fed back. It is also possible to use a bias or offset different from the encoder. Indeed, if the offset used on the encoder side corresponds to the inverse of the baseband energy decrease engendered by the baseband encoder, it may be desired that the same amount of energy decrease is also applied in the extended-band synthesis to match the energy levels of the two bands generated. In this case, the bias or offset can be ignored on the decoder side. Another solution is to insert a bias, this time independent of the baseband encoder bit-rate, but dependent on the gain quantizer used for the energy coding of the bandwidth extension coding. For example, to avoid overestimation due to quantization error, the bias can be equal to the opposite of the standard deviation of the gain quantization error.

FIG. 1b shows the usage of the above principle for a decoder. FIG. 1b shows a decoder 20 having an energy prediction entity 22 and a gain decoder 24. The energy prediction entity 22 is comparable to the energy prediction entity 12 and receives mainly the same inputs. The gain decoder 24 receives the output of the energy prediction entity 22, namely an energy prediction of the extended band signal, the energy parameters and a offset, which can be different from the one previously discussed or the same as the already discussed offset. Note the energy parameters received by the entity 24 are the parameters output by the gain encoder 14 at the encoder side 10.

The offset may depend on the given bit-rate or a coding mode or the combination of the two. The gain decoder 24 codes the extended band gains so as to output gain HBG.

Finally, in the case of a low bit budget, energy can be estimated at the decoder end only. In this case, energy prediction is performed and calculated from the parameters or signal already decoded from the baseband and/or extended-band encoder. This energy prediction as described before can already serve as a first estimate of the energy of the extended-band signal or of an intermediate extended-band signal. To further improve this prediction, a machine learning approach such as Deep Neural Networks can be used to estimate the residue of the prediction in a sort of regression task. The input can consist of all the information available at this stage from the band-limited decoder and band-extended decoder. This could be, for example, LPC coefficients, energies, voicing factors, magnitude spectra or a combination of these. The output is the estimated residual of the prediction, which refines the prediction to obtain an estimate of the energy of the extended-band signal, or of an intermediate signal used to synthesize the extended-band signal.

FIG. 1C shows another decoder 30 comprising the entities 32 for energy prediction and a gain estimator 34. The energy prediction entity 34 is comparable to the energy prediction entity 22 and 12 with regard to the inputs and the outputs or its processing as well. The gain estimator 34 uses a DNN. The entity 34 receives the energy prediction E_{HB} together with a frequency response of current and past decoded LB frames together with ÂHB(z). The entity 34 performs an estimation of the extended-band gains by estimating a residual of the energy prediction using a machine learning algorithm or using at least one learnable layer of parameters. The layer may, for example, be a fully connected layer or a convolutional layer or a recurrent layer.

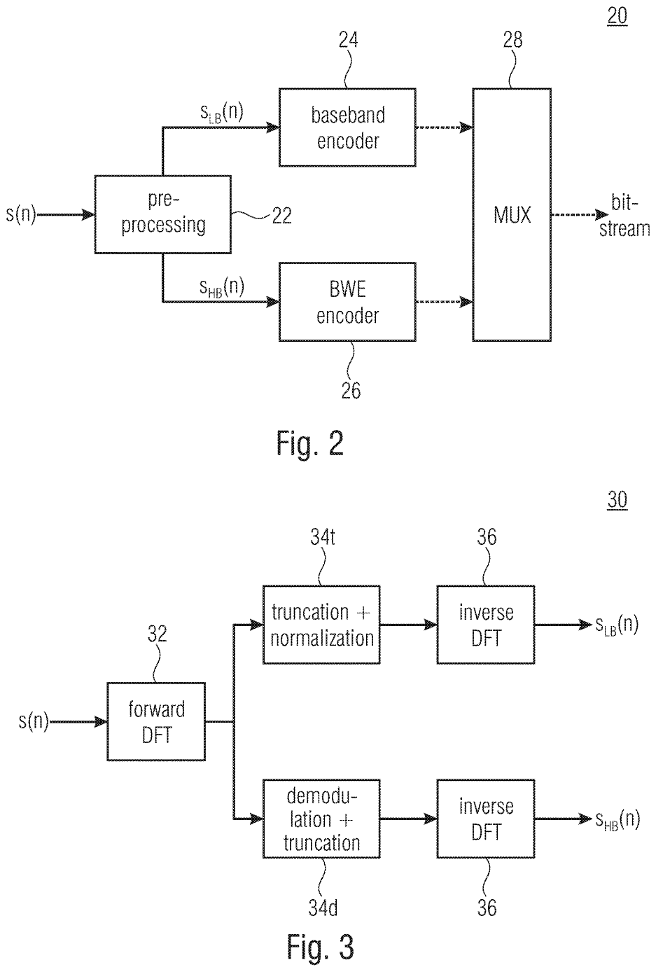

With respect to FIGS. 2 to 5, applications of the encoder 10 and the decoders 20 and 30 will be discussed.

FIG. 2 shows an encoder 20, a pre-processor 22, a baseband encoder 24 and a parallel BWE encoder 26.

The input signal is first conveyed to pre-processing block 22, which is in charge of converting of doing several analyses like a pitch estimation, a voice activity detection but also to convey signals sampling rate at a proper sampling rate to the subsequent coding modules, consisting in our case to baseband coder 24 and bandwidth extension 26. For this a filter-bank, like a QMF, pseudo QMF, modulated lapped or block transforms, or simply downsampling filters in time domain can be used.

The two signals conveyed to the baseband encoder 24 and the bandwidth extension (BWE) encoder 26 are usually at sampling rates lower than the sampling rate of the input signal s(n). The low band signal Sib (n) is composed of frequencies below a cross-over frequency which is usually the corresponding Nyquist frequency of its sampling-rate. On the other hand, the high band signal s_{hb}(n) is composed of frequencies above a cross-over frequency which is usually the corresponding Nyquist frequency of its sampling-rate. The HB and LB cross-over frequencies are usually the same. Therefore and in the usual case the two signals are complementary in frequency representation of the input signal and at the same time the whole multi-rate system is critically sampled. As an example, Sib (n) and s_{hb}(n) are both sampled at 16 kHz, s_{lb}(n) retaining frequencies from 0 to 8 kHz, and s_{hb}(n) retaining frequencies from 8 to 16 kHz. Another alternative is to have Sib (n) sampled at 12.8 kHz, composed of frequencies from 0 to 6.4 kHz and s_{hb}(n) sampled at 16 kHz composed of frequencies from 6.4 to 14.4 kHz. As in the filter-bank convention and in the subsequent description, the high-band signal (odd indexed band), is frequency reversed as illustrated in FIG. 3.

The low-band signal is conveyed to the baseband coder, which in our advantageous case is a CELP-based speech coding system, as in AMR-WB or 3GPP EVS. The s_{lb}(n) signal advantageously contains a broadband signal sampled at 12.8 or 16 KHz.

FIG. 3 shows a schematic block diagram of a two-band system realized with block transforms, for example DFTs. The two-band system comprises the forward DFT 32 and two parallel DFT strings. The one DFT string comprises truncation and normalization entity 34t and an inverse DFT 36, while the other string comprises a demodulator and truncation entity 34d and also an inverse DFT 36. The first string 34t plus 36 is used for the low band while the second string 34d plus 36 for the high band.

The truncation and normalization 34t of DFT spectrum serves as lowpass filtering and the Inverse DFT 36 is operating at a size corresponding to the target sampling rate for the low-band signal. For the high band, only the high frequencies are retained and copied and flipped to the baseband (aka known as demodulation, cf. 34d) before being decimated by the Inverse DFT 36 with a size corresponding to the sampling-rate of high-band signal.

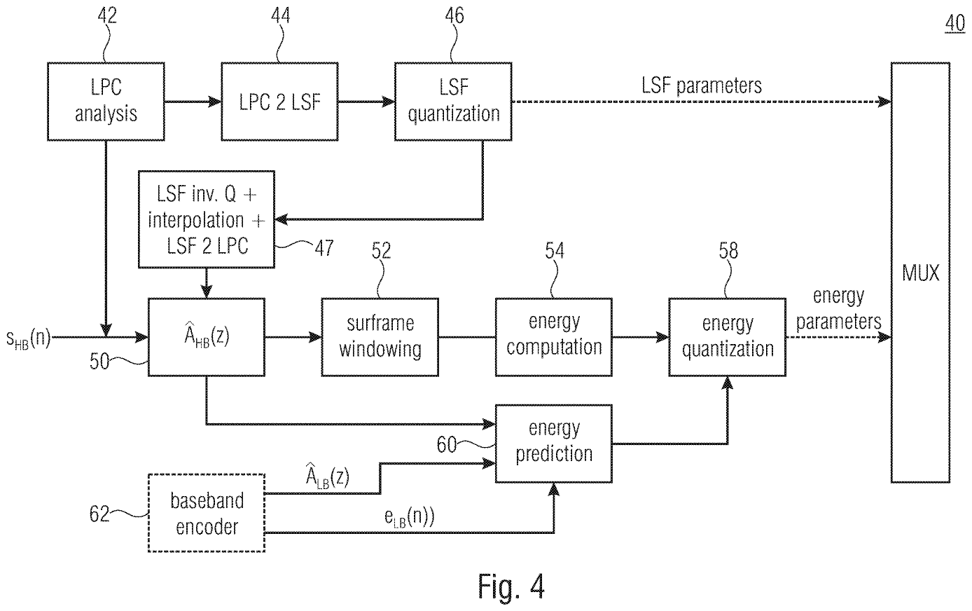

FIG. 4 illustrates a BWE encoder 40 comprising LPC analysis 42, LPC 2 LSF 44 and LSF quantization 46 enabling to output LSF parameters.

In parallel to a calculation of the LSF parameters, energy parameters are determined using the entities 50, 52 (subframe windowing), 54 (energy computation) and 56 (energy quantization). The energy quantization 56 is based on the energy computation 54 and the energy prediction 60 which gets the signal from the entity 50 and from a baseband coder 62. The entity 50 is connected with the input for the signal and the LSF quantization 46, via the entity 47.

The BWE encoder 40 receives the high-band signal s_{hb}(n) in order to extract the main salient parameters from it, namely its spectral shape and its energy. To do this, it follows a source-filter model like in CELP coding scheme and exploits the Linear Predictive Coding (LPC). LPC 42 and 44 is an adaptive filter that models the short-term linear prediction and, through duality between time and frequency domains, the spectral envelope of the signal. Quasi-optimality of LPC holds for near stationary segments, which for audio and speech signal can be considered for a duration of about 20 ms. Therefore, the signal is partitioned into 20 ms frames, and the LPC analysis 42 and parameter computation are performed at frame basis. For smoothing the transition, the LPC coefficients are further interpolated between adjacent frames, at a subframe level of duration 4 or 5 ms. The interpolation is performed by linear interpolation of LSFs (cf. 44 and 46).

An LPC analysis 42 aka short-term linear analysis is performed on s_{hb}(n) to obtain a set of LPC coefficients. Since speech and in general audio shows less structure or formant structure in the high frequencies, fewer parameters are required than for the low-band signal. In our advantageous mode, an order of 8 or 10 is used for a 16 kHz sampled s_{hb}(n) signal.

The LPC analysis is performed as it can be done in baseband encoder, that means, by windowing the signal, computing the autocorrelation function up to a maximum lag corresponding to the order, before finding the optimal prediction coefficients with a recursive algorithm like Levinson-Durbin. It is worth noting that the LPC analysis windows of both low and high band can be the same and advantageousl time aligned, which will be an advantage in the subsequent processing steps, but also for exploiting the same lookahead.

The so-obtained LPC coefficients are then quantized and coded. Once again since the spectral envelope of the high-band is usually less structured and also perceptually less relevant, quantization resolution can be lowered for the BWE coding compared to the baseband coding. For the quantization and the coding, a Vector quantization or a multi-stage vector quantization is advantageously applied after conversion of LPC coefficients to LSFs. Precomputed LSF means, obtained during an offline analysis on a dataset, is removed before quantization as well as a 1st order prediction obtained from the previously transmitted set of LSFs. The LSF residual are then vector quantized using from 8 to 16 bits per frame in an advantageous embodiment. The quantized LSFs are converted to quantized LPC coefficients to form the LPC analysis filter Â_{HB}(z) used to whiten the high-band signal and obtain the residual signal e_{HB}(n):

$${e}_{HB} ( n ) = {s}_{HB} ( n ) - {\sum }_{i = 1}^{{M}_{HB}} {a}_{i} {s}_{HB} ( n - i ) , n = 0 , … , {L}_{sub} - 1 ,$$

where M_{HB} is the LPC order, and L_{sub}, the size of the subframe for which the LPC coefficients are constant (Lsub=80 samples for 5 ms subframe at 16 kHz).

The energy of e_{HB}(n) is then computed (cf. 54) and coded per sub-frame of 4 to 5 ms (5 ms in our advantageous mode) using rectangular and non-overlapping windows (cf. 52). This way, an energy parameter can be transmitted at every 4/5 ms.

In order to save transmitted bits, the energy is not coded and quantized directly, but after a prediction exploiting the information derived from the low band. Only the residue of the energy prediction is then quantized. This information may be shared with the decoder, since the inverse prediction may be performed on the decoder side. For this purpose, if the baseband code is CELP-based, as in an advantageous mode, the ALB (z) low-band LPC analysis filter can be reused, using the quantized and transmitted LPC coefficients, as well as the coded excitation. Analysis of these two components, especially in the high frequencies of the low band, around the Nyquist frequency, gives a robust estimate of the high-band energy and the residual of the high-band LPC analysis. Still the residue of the energy prediction can be still show a mean which is not zero. The mean shift can moreover be dependent on the bit-rate since the prediction uses the excitation of the coded band-limited excitation, which varies with the allocated bit-rate. To compensate this means shift, or bias in the prediction, an offset or an inverse bias, can be applied to compensate the mean shift/bias. For a 20 ms framing, a set of 4 energy parameters are then obtained, and can be coded for example with a vector quantization using 7 bits. For even lower bit demand, the energy can be averaged (geometrically in the advantageous mode) over the frame size for the 4 subframes, to obtain 1 single value per frame to transmit. A 4 bit quantization is then enough. In the extreme case, only the estimate can used at the decoder without additional guidance from the encoder, corresponding then to a Obit quantization.

Possible BWE parameters and bit allocations are

| | Resolution | Bits | Bit-rate (kbps) |
|---|---|---|---|
| LSF parameters | 20 ms | 0/8/8/8/16 | 0/0.4/0.4/0.4/0.8 |
| Energy parameters | 5/20 ms | 0/0/4/7/7 | 0/0/0.2/0.35/0.35 |
| Total | | 0/8/12/15/23 | 0/0.4/0.6/0.75/1.15 |

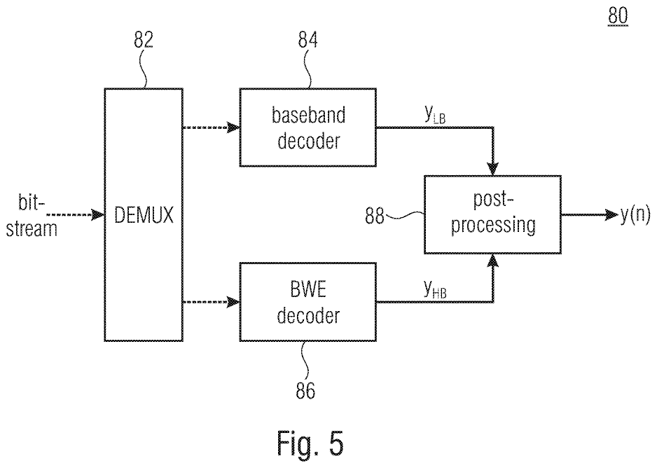

With respect to FIG. 5, a BWE decoder will be discussed. It comprises the demultiplexer 82, a baseband decoder 84 and a BWE decoder 86. Furthermore, the two decoded signals y_{lb} and y_{hb} are combined by the pre-processor 88 so as to obtain the signal y(n).

From the transmitted parameters, i.e. the coded LPC coefficients and coded energies, an artificially generated excitation is energy normalized and scaled, and then spectrally shaped by the synthesis LPC filter 1/Â_{HB}(z).

The generated y_{HB}(n) signal is then combined to the decoded low-band signal y_{LB}(n) to form the reconstructed signal y(n), as it is shown in FIG. 5, reference number 88. It can be achieved using a filter-bank, block transforms or time-domain up-sampling. In the advantageous embodiment, a complex-valued low-delay filter bank (CLDFB) as in described EVS, is used, which allows to perform additional post-processing steps in the filter-bank domain before combining the two components and transforming the signal back to the time-domain and at the desired sampling rate.

The following, we will give more details about the extended-band energy decoding, and more precisely the energy gain decoding.

The first step consist of reading the bits in the bitstream and dequantized the codebook indexes to a decoded gain values. It can be summarized as follows:

$$\hat{g} [ i ] = cdbk [ gindex ] [ i ] + bias ,$$

Wherein i is the index of subframe in case of the gain is transmitted in a subframe resolution. If the gain is transmitted only once a frame, i is then non-significant. The bias can be equal to the offset used at the encoder side. It can also be different, and dependent on different factors. For example, for matching the energy levels of the two decoded bands, the bias can be set to 0. It can also be set to this opposite of the quantization error standard deviation for avoiding any overestimation of the extend-band energy. In our advantageous embodiment the bias is constant and independent of the bit-rate and equal to −1.5 dB.

The final gain in dB applied to the generate extended-band excitation is then given by:

$${\hat{g}}^{′} [ i ] = \hat{g} [ i ] - 10 \cdot log 10 \frac{{\hat{E}}_{HB} [ i ]}{{\hat{E}}_{LB} [ i ] \cdot gpred [ i ]}$$

Where Ê_{HB}[i] is the energy of the generated-extended-band excitation, Ê_{LB}[i] the energy of band-limited excitation coded by the baseband encoder, and gpred[i], the prediction gain as computed at the encoder side. Below, an example of method for generating the extended-band excitation is given.

As an alternative and at low bit-rates the energy parameters can not be transmitted. In this case, a simple approach is to only use the energy prediction for the energy gain:

$${\hat{g}}^{″} [ i ] = - 10 \cdot log 10 \frac{{\hat{E}}_{HB} [ i ]}{{\hat{E}}_{LB} [ i ] \cdot gpred [ i ]} .$$

Another more advanced alternative at low bit-rates without transmitting the energy parameters, is to estimate the energy prediction reside g, by a machine learning approach like a deep neural network (DNN), which will estimate g[i] or g[i] by g[i]:

$${\hat{g}}^{′′′} [ i ] = \tilde{g} [ i ] - 10 \cdot log 10 \frac{{\hat{E}}_{HB} [ i ]}{{\hat{E}}_{LB} [ i ] \cdot gpred [ i ]} .$$

The DNN can be constituted by a series of layers, either fully connected layers, conventional layers or recursive layers, associated with activation functions, usually being non-linear functions, like ReLU, leaky ReLU or tanh. The input can be all information being available at the decoder at this point, like decoded parameters or signals from both the baseband decoder or the bandwidth-extension decoder, and the output the estimated energy prediction residue g. In order to make the prediction more context-sensitive, information from previous frames can also be included in the input of the DNN.

In the following an example is given for how such a DNN can be constructed:

For the input layer of a fully connected neural network, CLDFB values of 20 frequency subbands of the limited band are used at 16 time steps each for two previous frames and the current frame each. In addition to that, 128 spectral values of the frequency response of the LPC filter of the extended band in the current frame are used. This results in a total number of 1088 input features. These are fed successively through four fully connected hidden layers with 800, 400, 100, and 50 neurons each. Leaky ReLU functions are associated with the activations of the hidden layers. The output layer of the network consists of four neurons: one for each estimated gain \tilde{g}[i] of a subframe in the current frame. In this final layer, linear activation functions are used.

The above mentioned features are combinable with other aspects. According to embodiments, the coder may be enhanced as follows:

According to another embodiment in the above discussed principle may be combined for an audio processor for extended the audio bandwidth of a band-limited audio signal. This processor may be used in context of WESPE coders for coding a signal. The audio processor for extended the audio bandwidth of a band-limited audio signal comprises an envelope determiner, an analyzer for analyzing the temporal envelope, an excitation generator, an extended band generator, and a combiner. The envelope determiner is configured for determining a temporal envelope of at least a portion of a linear prediction residual of the band-limited audio signal or an excitation modelling the linear prediction residual of the band-limited audio signal (e.g., by peak picking and/or downsampling). The analyzer is configured for analyzing the temporal envelope to determine certain values of the temporal envelope. The excitation generator is configured for generating an excitation (signal, e.g. LPC residual/excitation signal of a low-band/baseband portion), e.g. by placing pulses in relation to the determined certain values, wherein the pulses are weighted using weights derived from the temporal envelope. The extended band generator is configured for generating an extended-band audio signal by processing the generated excitation. The combiner combining the band-limited audio signal with the generated extended-band audio signal to obtain a frequency enhanced audio signal.

Additionally or alternatively, the processor or encoder may be enhanced as follows:

According to another embodiment in the above discussed principle may be combined with an audio processor, like a coder for coding a signal, where the audio processor (coder) comprises a baseband processor or coder and a BWE entity or coder. The baseband processor coder may be configured to process or code a low band signal of the signal. The BWE entity coder may be configured to process or code a high band signal of the signal, the high band signal comprising a mixture of a first extended-band excitation and second extended-band excitation, wherein the BWE entity coder is configured to generate the first extended-band excitation and a noise generator configured to generate random noise as the second extended-band excitation; the mixture is controlled via a steering factor derived from a characteristics output by the baseband processor coder.

The invention may be computer implemented. Thus, embodiments of the present invention provide a method or computer implemented method for processing or encoding performing energy prediction of the extended-band signal based on LPC coefficients; and processing or encoding a residual of the signal using the energy prediction and an offset.

Furthermore, embodiments may refer to a decoding method. According to embodiments, the method or computer implemented method may comprise the steps of estimating energy prediction of the extended-band signal using a DNN; and decoding an extended-band signal of the signal using the energy prediction.

Additionally or alternatively, the method may comprise the steps: estimating energy prediction of the extended-band signal using a DNN; and decoding an extended-band signal of the signal using the energy prediction.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, some one or more of the most important method steps may be executed by such an apparatus.

An embodiment provides a method for encoding a signal comprising a band-limited signal and an extended-band signal, the method comprising:
encoding the bandlimited signal at a given bit-rate;
performing an energy prediction of the extended-band signal based on linear prediction coefficients; and
coding extended-band gains based on the energy prediction and an offset (o); wherein the offset (o) is dependent on the given bit-rate or a coding mode of baseband encoder.

Another embodiment provides a method for decoding a signal comprising a band-limited signal and an extended-band signal, the method comprising:
decoding the bandlimited signal at a given bit-rate;
performing energy prediction of the extended-band signal based on linear prediction coefficients; and
decoding an extended-band gains based on the energy prediction and an offset or a bias.

A further embodiment provides a method for decoding a signal comprising a band-limited signal and an extended-band signal, the method comprising:
decoding the bandlimited signal at a given bit-rate;
preforming energy prediction of the extended-band signal based on linear prediction coefficients; and
estimating an extended-band gains based on the energy prediction and an estimate of the energy prediction residue.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An encoder for coding an audio signal comprising a band-limited signal and an extended-band signal, the encoder comprising:
a baseband encoder configured to encode the band-limited signal at a given bit-rate; and
a bandwidth extension encoder which comprises:
an energy prediction calculator configured to perform an energy prediction of the extended-band signal based on linear prediction coefficients; and
a gain encoder configured to code extended-band gains based on the energy prediction and an offset;
wherein the offset is dependent on the given bit-rate or a coding mode of baseband encoder.

2. The encoder according to claim 1, wherein the linear prediction coefficients comprise prediction coefficients for the band-limited signal and the extended-band signal.

3. The encoder according to claim 1, wherein the linear prediction coefficients are Linear Predictive Coding coefficients.

4. The encoder according to claim 1, wherein the prediction calculator performs the energy prediction based on an coded band-limited excitation, and/or wherein the coded band-limited excitation is coded by the baseband encoder.

5. The encoder according to claim 1, wherein the extended-band gains are quantized using a codebook common to at least two bit-rates.

6. The encoder according to claim 1, wherein the prediction calculator is configured to compute a ratio of energies involving filters derived from the linear coefficients of the band-limited signal and the extended-band signal.

7. A decoder for decoding a signal comprising a band-limited signal and an extended-band signal, the decoder comprising:
a baseband decoder configured to decode the bandlimited signal at a given bit-rate; and
a bandwidth extension decoder which comprises: an energy prediction calculator configured to perform energy prediction of the extended-band signal based on linear prediction coefficients; and
an gain decoder configured to decode an extended-band gains based on the energy prediction and an offset or a bias.

8. The decoder according to claim 7, wherein the bias or the offset are dependent on a bit rate, a coding mode or a quantizer characteristic.

9. The decoder according to claim 7, wherein the prediction calculator is configured to compute a ratio of energies involving filters derived from the linear coefficients of the band-limited signal and the extended-band signal.

10. A decoder for decoding a signal comprising a band-limited signal and an extended-band signal, the decoder comprising:
a baseband decoder configured to decode the bandlimited signal at a given bit-rate; and
a bandwidth extension decoder which comprises:
a energy prediction calculator configured to perform energy prediction of the extended-band signal based on linear prediction coefficients; and
an gain estimator configured to estimate an extended-band gains based on the energy prediction and an estimate of the energy prediction residue.

11. The decoder according to claim 7, wherein the extended-band gains are estimated by estimating a residue of the energy prediction using a machine learning algorithm or using at least one learnable layer.

12. The decoder according to claim 11, wherein the at least one learnable layer comprises at least one fully connected layer or at least one convolutional layer or at least one recurrent layer.

13. The decoder according to claim 11, wherein the at least one learnable layer is associated with an activation function (like a ReLU, leaky ReLU . . . ).

14. The decoder according to claim 11, wherein the at least one learnable layer receives a frequency representation of the decoded band-limited band or of a filter derived from linear prediction coefficients as input.

15. The decoder according to the claim 14, wherein the at least one learnable layer takes as input a frequency representation of the decoded band-limited band of a current frame and at least one frequency representation of the decoded band-limited band of previous frames.

16. The decoder according to claim 7, wherein the prediction calculator configured to perform energy prediction of the extended-band signal based on linear prediction coefficients.

17. The decoder according to claim 7, wherein the extended-band excitation gains are applied to an extended-band excitation or an un-normalized extended-band signal in order to generate the extended-band signal.

18. A method for encoding a signal comprising a band-limited signal and an extended-band signal, the method comprising:
encoding the bandlimited signal at a given bit-rate; and
performing an energy prediction of the extended-band signal based on linear prediction coefficients; and
coding extended-band gains based on the energy prediction and an offset;
wherein the offset is dependent on the given bit-rate or a coding mode of baseband encoder.

19. A method for decoding a signal comprising a band-limited signal and an extended-band signal, the method comprising:
decoding the bandlimited signal at a given bit-rate, and
performing energy prediction of the extended-band signal based on linear prediction coefficients; and
decoding an extended-band gains based on the energy prediction and an offset or a bias; wherein the offset is dependent on the given bit-rate or a coding mode.

20. A method for decoding a signal comprising a band-limited signal and an extended-band signal, the method comprising:
decoding the bandlimited signal at a given bit-rate; and
preforming energy prediction of the extended-band signal based on linear prediction coefficients; and
estimating an extended-band gains based on the energy prediction and an estimate of the energy prediction residue.

21. A non-transitory digital storage medium having stored thereon a computer program for performing a method for decoding a signal comprising a band-limited signal and an extended-band signal, comprising:
decoding the bandlimited signal at a given bit-rate, and
performing energy prediction of the extended-band signal based on linear prediction coefficients; and
decoding an extended-band gains based on the energy prediction and an offset or a bias; wherein the offset is dependent on the given bit-rate or a coding mode,
when the computer program is run by a computer.
